(19) United States
(12) Patent Application Publication
(10) Pub. No.: US 2024/0057511 A1
(43) Pub. Date: Feb. 22, 2024

(54) SPLIT GAUGE-WHEEL ASSEMBLIES AND ROW UNITS HAVING SPLIT GAUGE-WHEEL ASSEMBLIES

(71) Applicant: Precision Planting LLC, Tremont, IL (US)

(72) Inventors: JEREMY J. HODEL, MORTON, IL (US); DOUGLAS WILLIAM URBANIAK, MACKINAW, IL (US); JORDAN CHARLES SOLBERG, EAST PEORIA, IL (US)

(21) Appl. No.: 17/820,293

(22) Filed: Aug. 17, 2022

(51) Int. Cl. A01C 7/06; A01C 5/06

(52) U.S. Cl. CPC A01C 7/06; A01C 5/062; A01C 5/066

(57) ABSTRACT

A split gauge-wheel assembly for a planter row unit includes an inner gauge wheel carried by the frame and configured to rotate about an axis and an outer gauge wheel carried by the frame and configured to rotate about the axis. The inner gauge wheel and outer gauge wheel define a gap therebetween. A knife is disposed in the gap between the inner gauge wheel and the outer gauge wheel, the knife defining a flow channel configured to deliver liquid at a rear end of the knife. A scraper is connected to the knife and disposed in the gap between the inner gauge wheel and the outer gauge wheel.

### FIELD

Embodiments of the present disclosure relate generally to machines for planting agricultural fields. In particular, embodiments relate to planters having gauge wheels for maintaining component height.

### BACKGROUND

Adding materials (such as fertilizers) adjacent to seed trenches during planting is a good way to provide the materials for growing plants to access during a later growing stage. This eliminates a pass over the field and may reduce soil compaction due to separate planting and material-application passes. However, not all of the fertilizer that a growing plant will need can be delivered in the seed trench without damaging the seed. Fertilizer placed adjacent to the seed trench can be used when the plant grows and extends into the zone where the fertilizer was placed.

Various implements are designed to deliver fertilizer to soil adjacent the trench on a planter row unit. These fertilizer applicators generally use coulters or knives to open a space adjacent the trench and include a liquid delivery tube for delivering fertilizer. These implements may be installed after the closing wheels on the row planter, or they can be installed between the closing wheels and the furrow discs. The drawback to these locations is that the overall length of each individual row unit is longer, and when folded for transport, the planter may be too wide for efficient travel over roads. Longer row units also impair the ability of a planter to make tight turns. Fertilizer may be applied in paths that can cross over previously planted furrows during turns, delivering fertilizer where it is not intended. Additionally, rear-mounted attachments are less consistent with vertical placement of liquid products because the fertilizer attachment trails the seed-delivery mechanism, causing the depth of the attachment to vary when topography is encountered.

Fertilizer applicators can also be installed ahead of the row unit. However, additional framework is needed to attach to the row unit, which increases costs. Forward-mounted fertilizer applicators can cause excessive disturbance to the soil near the seed furrow and can compromise precise placement of seeds and uniform emergence of seed. Forward-mounted fertilizer applicators also have the problem of depth consistency due to topography. Also, these implements can accumulate crop residue, which reduces their performance. U.S. Patent Application Publication 2019/0254226 A1, “Systems, Methods, and Apparatus for Agricultural Material Application,” published Aug. 22, 2019, discloses fertilizer delivery lateral to seed placement, which may alleviate some of these problems.

### BRIEF SUMMARY

In some embodiments, a split gauge-wheel assembly for a planter row unit includes an inner gauge wheel configured to rotate about an axis, and an outer gauge wheel configured to rotate about the axis. The inner gauge wheel and outer gauge wheel define a gap therebetween. A knife is disposed in the gap between the inner gauge wheel and the outer gauge wheel, the knife defining a flow channel configured to deliver liquid at a rear end of the knife. A scraper is connected to the knife and disposed in the gap between the inner gauge wheel and the outer gauge wheel.

In some embodiments, a row unit includes a frame, a furrow-opening assembly carried by the frame, at least one split gauge-wheel assembly, and a furrow-closing assembly coupled to the frame. The at least one split gauge-wheel assembly is coupled to the furrow-opening assembly such that the at least one split gauge-wheel assembly travels along a surface of an agricultural field and controls a depth of the furrow-opening assembly relative to the field when the row unit travels through the field. The at least one split gauge-wheel assembly includes an inner gauge wheel configured to rotate about an axis, and an outer gauge wheel configured to rotate about the axis. The inner gauge wheel and outer gauge wheel define a gap therebetween. A knife is disposed in the gap between the inner gauge wheel and the outer gauge wheel, and defines a flow channel configured to deliver liquid at a rear end of the knife. A scraper is connected to the knife and disposed in the gap between the inner gauge wheel and the outer gauge wheel.

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments of the disclosure when read in conjunction with the accompanying drawings, in which:

FIG. 1 is a rear perspective view of a planter row unit having split gauge wheels;

FIG. 2 is a perspective view showing gauge-wheel assemblies of the row unit shown in FIG. 1;

FIG. 3 is a rear view of the gauge-wheel assemblies shown in FIG. 2;

FIG. 4 is a side view of a knife of the gauge-wheel assemblies shown in FIG. 2; and

FIG. 5 is a simplified drawing illustrating how the knife may improve consistency of fertilizer application.

### DETAILED DESCRIPTION

All references cited herein are incorporated herein in their entireties. If there is a conflict between definitions herein and in an incorporated reference, the definition herein shall control.

The illustrations presented herein are not actual views of any particular planter, but are merely idealized representations that are employed to describe example embodiments of the present disclosure. Additionally, elements common between figures may retain the same numerical designation.

The following description provides specific details of embodiments of the present disclosure in order to provide a thorough description thereof. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. Also note, the drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter).

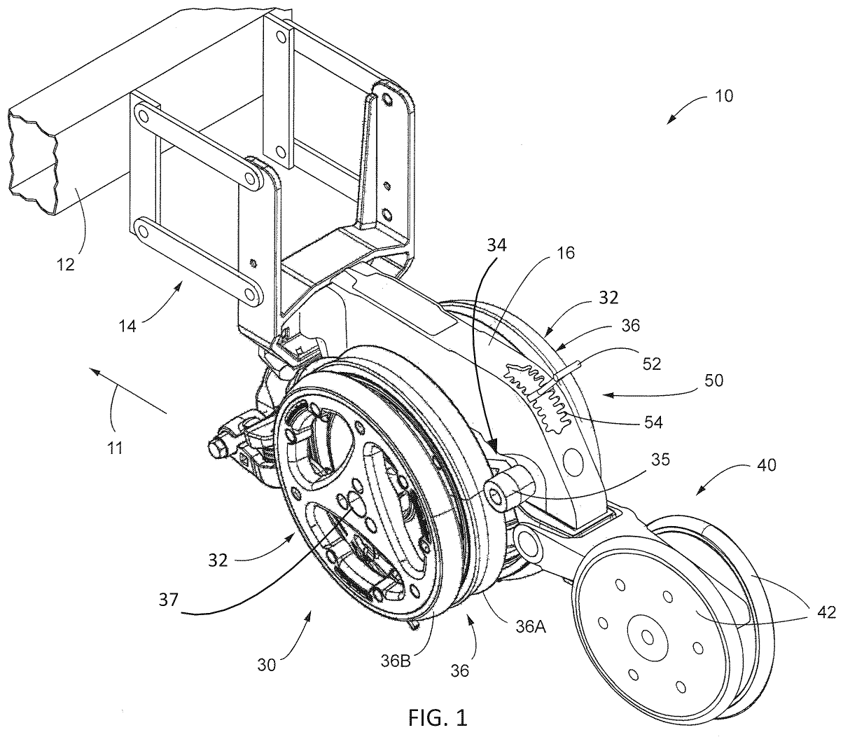

FIG. 1 shows a rear perspective view of a planter row unit 10 of an agricultural planter. Although only one row unit 10 is shown, the planter may include a plurality of row units 10 spaced along a toolbar 12, each supported from the toolbar 12 by a parallel linkage 14 that permits each row unit 10 to move vertically independently of the toolbar 12 and the other row units 10. The row unit 10 includes a row unit frame 16 that supports a furrow-opening assembly 30 and a furrow-closing assembly 40. The row unit frame 16 may also support a seed meter, a seed tube or seed conveyor, and a mini-hopper (for a central fill planter) or one or more larger hoppers (for a conventional planter row unit). The seed meter, seed tube, and mini-hopper are omitted from FIG. 1 for clarity, but are depicted, for example, in FIG. 1 of U.S. Patent Application Publication 2019/0254226, “Systems, Methods, and Apparatus for Agricultural Material Application,” published Aug. 22, 2019.

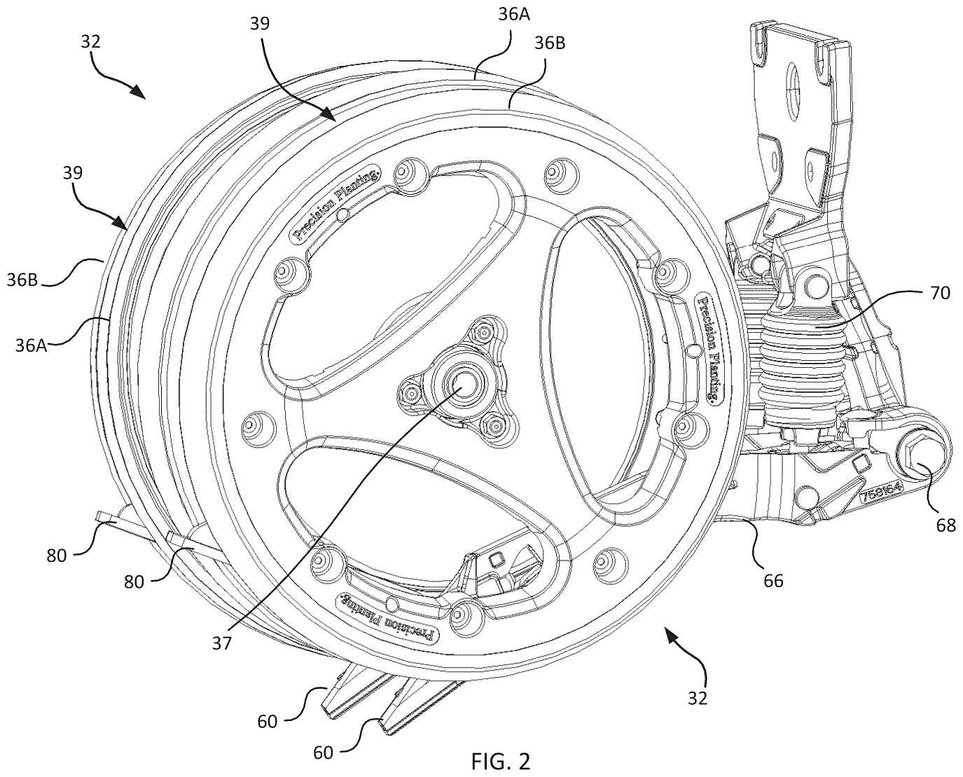

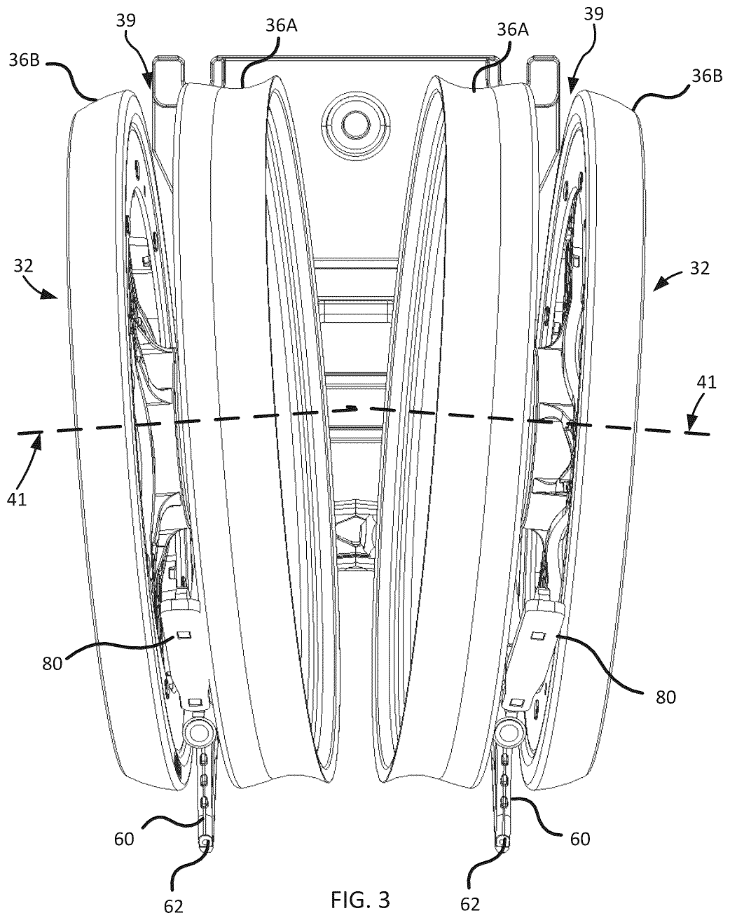

The furrow-opening assembly 30 includes left and right gauge-wheel assemblies 32 carried by the row unit frame 16. FIG. 2 shows the gauge-wheel assemblies 32 removed from the row unit frame 16 for clarity. FIG. 3 shows a rear view the gauge-wheel assemblies 32 removed from the row unit frame 16. The gauge-wheel assemblies 32 each include a split gauge wheel 36 comprising an inner gauge wheel 36A and an outer gauge wheel 36B, which are spaced apart laterally, resulting in a gap or space 39 between the inner and outer wheels 36A, 36B. In some embodiments, the gauge wheels 36A, 36B may be a unitary structure with a groove, rather than gap 39. Any such gaps, spaces, or grooves are referred to below as simply “gap 39.” The inner and outer gauge wheels 36A, 36B are connected to a wheel hub 37 and configured to rotate about an axis 41 centered in the wheel hub 37. In embodiments in which the row unit 10 has two gauge-wheel assemblies 32, the axes 41 about which the inner and outer gauge wheels 36A, 36B rotate may be angled with respect to one another.

As shown in FIG. 1, each gauge-wheel assembly 32 includes a gauge-wheel arm 34 pivotally supported at one end from the row unit frame 16 at an arm hub 35. The other end of the gauge-wheel arm 34 extends forwardly from the arm hub 35 and rotatably supports the gauge wheel 36 at the wheel hub 37. On some planters, the gauge-wheel arm 34 is oriented in the opposite direction, i.e., with the arm hub 35 mounted to a forward shank of the row unit frame 16 and the gauge-wheel arm 34 extending rearwardly to support the gauge wheel 36. The furrow-opening assembly 30 further includes a pair of furrow-opening discs disposed between the left and right gauge-wheel assemblies 32, for example, as shown in FIG. 3 of U.S. Patent Application Publication 2019/0254226. The furrow-opening discs cut a furrow in the soil as the row unit 10 travels in a forward direction as indicated by arrow 11. The seed tube or seed conveyor extends downwardly from the seed meter and between the furrow opening discs. The seed tube directs the seed discharged by the seed meter into the open seed furrow before the open furrow is closed by the furrow-closing assembly 40. The furrow-closing assembly includes a pair of closing wheels 42, each disposed on opposite sides of the furrow formed by the opening discs. The closing wheels 42 are oriented to close the furrow by pushing the soil into the open seed furrow covering the previously deposited seed.

A depth adjustment assembly 50 is used to set the depth of the furrow to be cut by the opening discs. The depth adjustment assembly 50 includes a handle 52 that engages with channels 54 in the row unit frame 16 for selectively positioning a stop member or rocker that engages with the gauge-wheel arms 34 to limit the amount of vertical travel of the gauge-wheel arms 34 relative to the furrow-opening discs, thus setting the depth at which the furrow-opening discs are able to penetrate into the soil below the gauge wheels 36.

As shown in FIG. 2 and FIG. 3, each gauge-wheel assembly 32 has a knife 60 disposed between the inner and outer gauge wheels 36A, 36B. The knife 60 extends below the surface of the ground when the gauge wheels 36A, 36B travel along the ground. The knife 60 forms a trench into which a fertilizer material can be delivered.

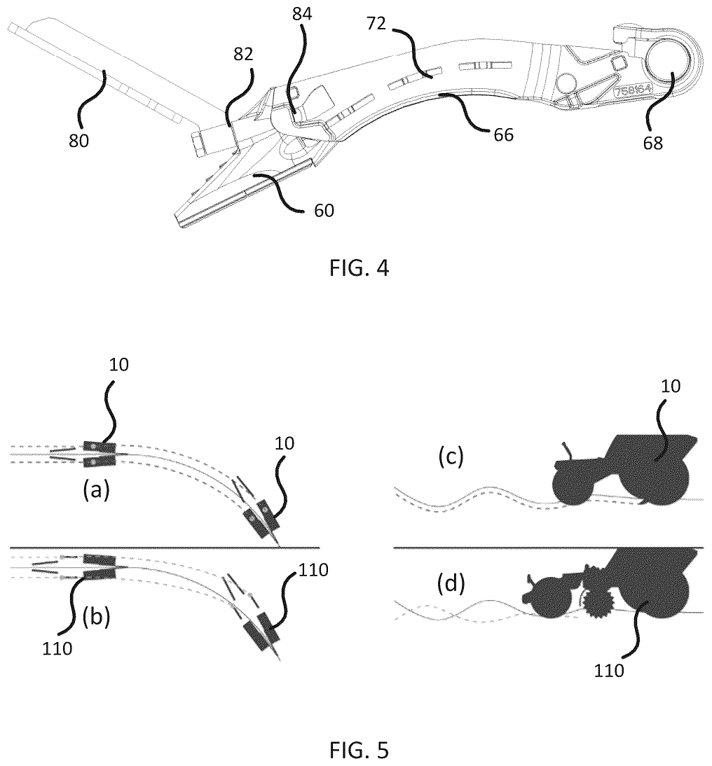

FIG. 4 is a side view of the knife 60 attached to an arm 66. The arm 66 is configured to rotate about a pivot point 68 mounted to the row unit frame 16, and may be controlled by a biasing member 70 (FIG. 2) (e.g., a spring, an actuator, etc.). The knife 60 may define a flow channel 62 therein (FIG. 3), such that liquid fertilizer can be delivered into the trench as the knife 60 traverses a field. The arm 66 may define a channel 72 in which tubing can be routed to provide the liquid fertilizer from a reservoir to the flow channel 62 of the knife 60.

As the gauge wheels 36A, 36B travel along the ground, soil and residue may adhere to surfaces of the gauge wheels 36A, 36B. A scraper may be configured to remove built-up soil and residue from the outside diameter of the gauge wheels 36A, 36B (i.e., the surfaces directly contacting the ground), such as a scraper as described in U.S. Patent Application Publication 2018/0103570, “Scraper Blade for Depth Gauge Wheel,” published Apr. 19, 2018.

Because soil and residue may also accumulate on the lateral surfaces of the gauge wheels 36A, 36B, and because soil and residue between the gauge wheels 36A, 36B may interfere with the knife 60, a scraper 80 may connected to the knife 60 and disposed between the inner and outer gauge wheels 36A, 36B. The scraper 80 may knock built-up soil and residue from the lateral surfaces of the gauge wheels 36A, 36B within the gap 39. The soil and residue may fall to the ground behind the knife 60, and after the fertilizer has been applied, such that the material knocked from the gauge wheels 36A, 36B does not interfere with the application of the fertilizer in the trench formed by the knife 60.

The scraper 80 may be pivotally attached to the knife 60, such that when the gauge wheels 36A, 36B shift to one side or the other due to turning of the planter, the scraper 80 can move with the gauge wheels 36A, 36B and remain in the gap 39. For example, the scraper 80 may be mounted to the knife 60 by a pivoting bushing 82 and a bolt 84. The scraper 80 may be angled upward from the knife 60 so that the scraper 80 does not touch the ground.

The presence of the scraper 80 may enable the knife 60 to operate freely within the gap 39, without interference from debris dropping in its path. If the knife 60 is placed within the gap 39, it may be more laterally aligned with the seed placement mechanism than if the knife 60 is in front of or behind the gauge-wheel assemblies 32. Furthermore, the knife 60 may be guided by the gauge wheels 36A, 36B so that fertilizer placement is at a fixed distance from the seeds. Dispensing fertilizer laterally from the seed placement, with little or no forward or rearward displacement, enables the planter to keep the fertilizer at a selected distance from the seeds, and thus enables more uniform availability of fertilizer at an appropriate time in the growth of the seeds. FIG. 5 is a simplified drawing illustrating how locating the fertilizer application in a knife laterally from the seed application can improve consistency of spacing. In (a) and (c), row unit 10 applies fertilizer laterally from the seed. In (b) and (d), conventional row unit 110 applies fertilizer behind the seed. Comparing top views (a) and (b) shows that the distance between the seed row (solid line) and the fertilizer (dotted lines) going around a curve may be more consistent for the row unit 10 than for the row unit 110. Fertilizer placement laterally from the seeds may also improve depth consistency, because the fertilizer and seeds follow the same contour. Comparing side view (c) and (d) shows that the fertilizer depth (dotted lines) in uneven seedbeds can better match the contour of the ground if applied laterally from the seeds, between the inner and outer gauge wheels 36A, 36B. Consistent fertilizer spacing may ultimately increase the crop yield and farm profitability.

Since the knife 60 is mounted to the row unit frame 16, it does not interfere with the function of the gauge wheels 36A, 36B in providing consistent and proper seeding depth. Placement of the knife 60 and scraper 80 between the gauge wheels 36A, 36B may also allow fertilizer to be applied without increasing the length of the row unit 10. Furthermore, the scraper 80 may improve the performance of the gauge wheels 36A, 36B and the knife 60 in muddy conditions.

Additional non limiting example embodiments of the disclosure are described below.

Embodiment 1: A split gauge-wheel assembly for a planter row unit, the assembly comprising an inner gauge wheel configured to rotate about an axis and an outer gauge wheel configured to rotate about the axis. The inner gauge wheel and outer gauge wheel define a gap therebetween. A knife is disposed in the gap between the inner gauge wheel and the outer gauge wheel, the knife defining a flow channel configured to deliver liquid at a rear end of the knife. A scraper is connected to the knife and disposed in the gap between the inner gauge wheel and the outer gauge wheel.

Embodiment 2: The assembly of Embodiment 1, wherein the inner gauge wheel and the outer gauge wheel form a unitary structure.

Embodiment 3: The assembly of Embodiment 1 or Embodiment 2, wherein the inner gauge wheel and the outer gauge wheel are each connected to a hub.

Embodiment 4: The assembly of Embodiment 3, further comprising a gauge-wheel arm connected to the hub.

Embodiment 5: The assembly of any of Embodiment 1 through Embodiment 4, wherein the scraper is pivotally attached to the knife.

Embodiment 6: The assembly of Embodiment 5, wherein the scraper is connected to the knife by a pivot bushing.

Embodiment 7: The assembly of any of Embodiment 1 through Embodiment 6, wherein the knife is carried by an arm pivotally attached to a frame of a row unit.

Embodiment 8: The assembly of Embodiment 7, further comprising a biasing member configured to apply a force on the arm.

Embodiment 9: The assembly of any of Embodiment 1 through Embodiment 8, wherein the knife defines a liquid flow channel therein.

Embodiment 10: A row unit, comprising a frame; a furrow-opening assembly carried by the frame; at least one split gauge-wheel assembly, and a furrow-closing assembly coupled to the frame. The at least one split gauge-wheel assembly is coupled to the furrow-opening assembly such that the at least one split gauge-wheel assembly travels along a surface of an agricultural field and controls a depth of the furrow-opening assembly relative to the field when the row unit travels through the field. The at least one split gauge-wheel assembly comprises an inner gauge wheel configured to rotate about an axis and an outer gauge wheel configured to rotate about the axis. The inner gauge wheel and outer gauge wheel define a gap therebetween. A knife is disposed in the gap between the inner gauge wheel and the outer gauge wheel, the knife defining a flow channel configured to deliver liquid at a rear end of the knife. A scraper is connected to the knife and disposed in the gap between the inner gauge wheel and the outer gauge wheel.

Embodiment 11: The row unit of Embodiment 10, wherein the row unit is configured to dispose fertilizer laterally from seed.

Embodiment 12: The assembly of Embodiment 10 or Embodiment 11, wherein the inner gauge wheel and the outer gauge wheel form a unitary structure.

Embodiment 13: The assembly of any of Embodiment 10 through Embodiment 12, wherein the inner gauge wheel and the outer gauge wheel are each connected to a hub.

Embodiment 14: The assembly of Embodiment 13, further comprising a gauge-wheel arm connected to the frame and supporting the hub.

Embodiment 15: The assembly of any of Embodiment 10 through Embodiment 14, wherein the scraper is pivotally attached to the knife.

Embodiment 16: The assembly of Embodiment 15, wherein the scraper is connected to the knife by a pivot bushing.

Embodiment 17: The assembly of any of Embodiment 10 through Embodiment 16, wherein the knife is carried by an arm pivotally attached to the frame.

Embodiment 18: The assembly of Embodiment 17, further comprising a biasing member configured to apply a force on the arm.

Embodiment 19: The assembly of any of Embodiment 10 through Embodiment 18, wherein the knife defines a liquid flow channel therein.

Embodiment 20: The assembly of any of Embodiment 10 through Embodiment 19, wherein the at least one split gauge-wheel assembly comprises a first split gauge-wheel assembly and a second split gauge-wheel assembly, wherein the axis about which the gauge wheels of the first split gauge-wheel assembly rotate is angled with respect to the axis about which the gauge wheels of the second split gauge-wheel assembly rotate.

While the present invention has been described herein with respect to certain illustrated embodiments, those of ordinary skill in the art will recognize and appreciate that it is not so limited. Rather, many additions, deletions, and modifications to the illustrated embodiments may be made without departing from the scope of the invention as hereinafter claimed, including legal equivalents thereof. In addition, features from one embodiment may be combined with features of another embodiment while still being encompassed within the scope of the invention as contemplated by the inventors. Further, embodiments of the disclosure have utility with different and various planter types and configurations.

1. A split gauge-wheel assembly for a planter row unit, the assembly comprising:
an inner gauge wheel configured to rotate about an axis;
an outer gauge wheel configured to rotate about the axis, wherein the inner gauge wheel and outer gauge wheel define a gap therebetween;
a knife disposed in the gap between the inner gauge wheel and the outer gauge wheel, the knife defining a flow channel configured to deliver liquid at a rear end of the knife; and
a scraper connected to the knife and disposed in the gap between the inner gauge wheel and the outer gauge wheel.

2. The assembly of claim 1, wherein the inner gauge wheel and the outer gauge wheel form a unitary structure.

3. The assembly of claim 1, wherein the inner gauge wheel and the outer gauge wheel are each connected to a hub.

4. The assembly of claim 3, further comprising a gauge-wheel arm connected to the hub.

5. The assembly of claim 1, wherein the scraper is pivotally attached to the knife.

6. The assembly of claim 5, wherein the scraper is connected to the knife by a pivot bushing.

7. The assembly of claim 1, wherein the knife is carried by an arm pivotally attached to a frame of a row unit.

8. The assembly of claim 7, further comprising a biasing member configured to apply a force on the arm.

9. The assembly of any of claim 1, wherein the knife defines a liquid flow channel therein.

10. A row unit, comprising:
a frame;
a furrow-opening assembly carried by the frame;
at least one split gauge-wheel assembly coupled to the furrow-opening assembly such that the at least one split gauge-wheel assembly travels along a surface of an agricultural field and controls a depth of the furrow-opening assembly relative to the field when the row unit travels through the field, the at least one split gauge-wheel assembly comprising:
an inner gauge wheel configured to rotate about an axis;
an outer gauge wheel configured to rotate about the axis, wherein the inner gauge wheel and outer gauge wheel define a gap therebetween;
a knife disposed in the gap between the inner gauge wheel and the outer gauge wheel, the knife defining a flow channel configured to deliver liquid at a rear end of the knife; and
a scraper connected to the knife and disposed in the gap between the inner gauge wheel and the outer gauge wheel; and
a furrow-closing assembly coupled to the frame.

11. The row unit of claim 10, wherein the row unit is configured to dispose fertilizer laterally from seed.

12. The assembly of claim 10, wherein the inner gauge wheel and the outer gauge wheel form a unitary structure.

13. The assembly of claim 10, wherein the inner gauge wheel and the outer gauge wheel are each connected to a hub.

14. The assembly of claim 13, further comprising a gauge-wheel arm connected to the frame and supporting the hub.

15. The assembly of claim 10, wherein the scraper is pivotally attached to the knife.

16. The assembly of claim 15, wherein the scraper is connected to the knife by a pivot bushing.

17. The assembly of claim 10, wherein the knife is carried by an arm pivotally attached to the frame.

18. The assembly of claim 17, further comprising a biasing member configured to apply a force on the arm.

19. The assembly of claim 10, wherein the knife defines a liquid flow channel therein.

20. The assembly of claim 10, wherein the at least one split gauge-wheel assembly comprises a first split gauge-wheel assembly and a second split gauge-wheel assembly, wherein the axis about which the gauge wheels of the first split gauge-wheel assembly rotate is angled with respect to the axis about which the gauge wheels of the second split gauge-wheel assembly rotate.
